(19) United States
(12) Patent Application Publication
(10) Pub. No.: US 2026/0358462 A1
(43) Pub. Date: Nov. 12, 2026

(54) DEVICE ORIENTATION AND POSITIONING USING LOCAL AND GLOBAL COORDINATE SYSTEMS

(71) Applicant: Lenovo (Singapore) Pte. Ltd., Singapore (SG)

(72) Inventors: Colin FRANK, Park Ridge, IL (US); Robin Rajan THOMAS, Bad Nauheim (DE)

(21) Appl. No.: 19/129,465

(22) PCT Filed: Nov. 13, 2023
(86) PCT No.: PCT/IB2023/061452

§ 371 Date: May 13, 2025

Related U.S. Application Data
(60) Provisional application No. 63/383,740, filed on Nov. 15, 2022.

(51) Int. Cl. G01S 5/08

(52) U.S. Cl. CPC G01S 5/08

(57) ABSTRACT

Various aspects of the present disclosure relate to orienting a target device in a global coordinate system using measurements in a local coordinate system. An exemplary method includes receiving a plurality of angle-of-arrival values, each of the angle-of-arrival values representing an angle between the target device and a respective reference device within a global coordinate system, measuring angle-of-arrival values between the target device and each of the respective reference devices within a local coordinate system of the target device, calculating a first rotation value between a first axis of the global coordinate system and a first axis of the local coordinate system, calculating a second rotation value between a second axis of the global coordinate system and a second axis of the local coordinate system, and calculating a third rotation value between a third axis of the global coordinate system and a third axis of the local coordinate system.

### CROSS REFERENCE TO RELATED APPLICATIONS

This application claims priority to U.S. Provisional Patent Application No. 63/383,740, filed on Nov. 15, 2022, which is hereby incorporated by reference in its entirety.

### TECHNICAL FIELD

The present disclosure relates to wireless communications, and more specifically to devices and methods for orienting a target device in a global coordinate system using local coordinate measurements.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Device positioning is an increasingly important element of wireless communication devices. Device positioning is very useful for technologies such as automated or semi-automated vehicle piloting, in which devices may exchange position information and determine appropriate pathing based on the exchanged information. If the positioning information is not accurate, the vehicles could collide with one another.

While wireless networks employ various positioning technologies, many of those technologies are inaccurate, not always available, or require special conditions.

### SUMMARY

The present disclosure relates to methods, apparatuses, and systems that support orienting a target device in a global coordinate system using local coordinate measurements. The device may be oriented by determining rotation values between a local coordinate system of a target device and a global coordinate system.

Some implementations of the method and apparatuses described herein may further include receiving a plurality of angle-of-arrival values, each of the angle-of-arrival values representing an angle between the target device and a respective reference device within a global coordinate system, measuring angle-of-arrival values between the target device and each of the respective reference devices within a local coordinate system of the target device, calculating a first rotation value between a first axis of the global coordinate system and a first axis of the local coordinate system, calculating a second rotation value between a second axis of the global coordinate system and a second axis of the local coordinate system, and calculating a third rotation value between a third axis of the global coordinate system and a third axis of the local coordinate system.

In some implementations of the method and apparatuses described herein, the target device transmits a request for the plurality of angle-of-arrival values within the global coordinate system to a positioning entity.

In some implementations of the method and apparatuses described herein, the target device transmits a request for the plurality of angle-of-arrival values for reference devices within a predetermined distance range from the target device to a positioning entity.

In some implementations of the method and apparatuses described herein, the target device transmits the first, second and third rotation values to a positioning entity.

In some implementations of the method and apparatuses described herein, the target device converts the angle of arrival values between the target device and each of the respective reference devices within a local coordinate system of the target device to angle of arrival values within the global coordinate system, and transmits the angle of arrival values within the global coordinate system to a positioning entity.

In some implementations of the method and apparatuses described herein, the target device uses at least three angle-of-arrival values for at least three respective reference devices to calculate the first, second and third rotation values.

Some implementations of the method and apparatuses described herein may further include calculating a plurality of angle-of-arrival values, each of the angle-of-arrival values representing an angle between a target device and a respective reference device within a global coordinate system, receiving angle-of-arrival values between the target device and each of the respective reference devices within a local coordinate system of the target device, calculating a first rotation value between a first axis of the global coordinate system and a first axis of the local coordinate system, calculating a second rotation value between a second axis of the global coordinate system and a second axis of the local coordinate system, and calculating a third rotation value between a third axis of the global coordinate system and a third axis of the local coordinate system.

In some implementations of the method and apparatuses described herein, a positioning entity receives a second plurality of angle-of-arrival values within the local coordinate system from the target device, and converts the second plurality of angle-of-arrival values within the local coordinate system to a second plurality of angle-of-arrival values within the global coordinate system using the first, second and third rotation values.

In some implementations of the method and apparatuses described herein, the positioning entity determines a location of the target device using the first, second and third rotation values.

In some implementations of the method and apparatuses described herein, the positioning entity compares a set of candidate devices to a first distance from the target device and a second distance from the target device, and the reference devices are selected from candidate devices that are greater than the first distance and less than the second distance from the target device.

### BRIEF DESCRIPTION OF THE DRAWINGS

FIG. 1 illustrates an example of a wireless communications system that supports determining the orientation of a local coordinate system relative to a global coordinate system in accordance with aspects of the present disclosure.

FIG. 2 illustrates an example of beam positioning in an NR network.

FIG. 3 illustrates an example of absolute and relative positioning in wireless cellular networks.

FIG. 4 illustrates an example of a multi-cell round-trip time (RTT) procedure in a wireless network.

FIG. 5 illustrates an example of relative range estimation using RTT and a single gNB.

FIG. 6 illustrates a flowchart of a method that supports determining the orientation of a local coordinate system relative to a global coordinate system in accordance with aspects of the present disclosure.

FIG. 7 illustrates an example of devices that supports determining the orientation of a local coordinate system relative to a global coordinate system in accordance with aspects of the present disclosure.

FIG. 8 illustrates an example of a block diagram of a UE device that supports determining the orientation of a local coordinate system relative to a global coordinate system in accordance with aspects of the present disclosure.

FIG. 9 illustrates an example of a block diagram of a positioning entity that supports determining the orientation of a local coordinate system relative to a global coordinate system in accordance with aspects of the present disclosure.

FIG. 10 illustrates a flowchart of a method that supports determining the orientation of a local coordinate system relative to a global coordinate system in accordance with aspects of the present disclosure.

FIG. 11 illustrates an example of uncertainty in AoA values that supports determining the orientation of a local coordinate system relative to a global coordinate system in accordance with aspects of the present disclosure.

FIG. 12 illustrates an example of different coordinate systems that supports determining the orientation of a local coordinate system relative to a global coordinate system in accordance with aspects of the present disclosure.

FIGS. 13 and 14 illustrate flowcharts of methods that support determining the orientation of a local coordinate system relative to a global coordinate system in accordance with aspects of the present disclosure.

FIG. 15 illustrates an example of a processor that supports determining the orientation of a local coordinate system relative to a global coordinate system in accordance with aspects of the present disclosure.

### DETAILED DESCRIPTION

There is a lack of supported procedures for determining the relationship between the local coordinate system (LCS) and global coordinate system (GCS) between two distributed devices, which may be user equipment (UE) or other nodes in a wireless network, which can be used for determining orientation in sidelink (SL) positioning. The angular measurements performed using either the LCS or GCS should be translatable for determining a target UE's own orientation with respect to another device or reporting the required parameters for another device to determine its orientation with respect to the target UE.

If the device is a fixed device, then the orientation may be fixed or determined at the time of installation. If the device is mounted on a vehicle, then the vehicle may provide the device with the orientation of the vehicle and/or of the device. Other methods for determining the orientation of a device could involve the use of a compass or a level, but mobile devices may not incorporate these. For the general case, there is no existing method to determine the orientation of the device and the LCS to GCS mapping.

Although a positioning framework exists in 3GPP specifications which enables Uu interface UE-assisted and UE-based positioning methods, there is currently a lack of support for efficient UE-to-UE range/orientation determination, which is important for supporting relative positioning applications across different vertical services, e.g., V2X, Public Safety, Industrial Internet of Things (IIoT), Commercial, etc.

Embodiments of the present disclosure relate to devices and positioning entities configured to determine a relationship between the device LCS and the GCS. In one embodiment, a positioning entity or the network to which the device is attached knows the location of the target device as well as the locations of the other devices within proximity of the target device, all within a common coordinate system. The positioning entity can cause the computed angles of arrivals of these devices in the GCS, relative to the target device, to be signaled to the target device. The target device may then measure these same angles of arrival in the local coordinate system, and use these two sets of angles to solve for the rotations alpha, beta, and gamma that define the relationship between its LCS and the GCS. The target device signals the relationship between its LCS and the GCS to the positioning entity, or alternatively, signals the AOA's to the positioning entity in the GCS. These and other embodiments will be described in more detail in the following disclosure.

Some devices have arrays that are able to take measurements of the angle of arrival of signals received from other devices. Initially, these angles are measured in the local coordinate system of the device taking the measurements. For these measurements to assist in determining the location of the device taking the measurement or of the devices for which the angle of arrival is being measured, it must be possible to determine the relationship of the angles in the local coordinate system and the angles in the global coordinate system. This disclosure provides a method for determining this relationship.

The present disclosure describes a method for determining the relationship, in terms of rotation angles α, β, and γ, between the LCS of a device and the GCS. If the device has knowledge of the AOA of some set of devices in the GCS for which the device can take AOA measurements in the LCS, the set of rotations α, β, and γ can be determined by solving a set of linear equations. Generally, at least three measurements are used to solve for these rotations. However, in the case that some of the rotations are known, the remaining rotations can be determined using a number of measurements equal to the number of unknown rotations.

In one embodiment, the locations of a target device and a set of other devices in proximity of the target device are known to the network or a positioning entity. The positioning entity or network cause the locations to be sent to the target device. The target device uses these locations to compute the AoAs of the signals received from the neighboring devices in the GCS. The target device then measures the AoAs of these signals in the LCS. The computed GCS AoAs and the measured LCS AoAs can be used to determine the rotations α, β, and γ. With these rotations, the target device can convert LCS AOA measurements to GCS before signalling these measurements to the positioning entity or network.

In a second embodiment, a positioning entity or the network to which the target device is attached knows the location of the target device as well as the locations of the other devices within proximity of the target device, all within a common coordinate system. The positioning entity can cause the computed angles of arrivals of these devices in the GCS, relative to the target device, to be signalled to the target device. The target device then measures these same angles of arrival in the local coordinate system. The device uses these two sets of angles to solve for the rotations α, β, and γ that define the relationship between its LCS and the GCS. The target device signals the relationship between its LCS and the GCS to the positioning entity, or alternatively, signals the AoAs to the positioning entity in the GCS.

In a third embodiment, the positioning entity or the network have knowledge of the locations of the target device and other devices in proximity of the target device. Based on this knowledge, the network computes the angles of arrivals in the GCS of signals received by the target device from the other devices in the proximity of the target device. The target device reports LCS AoA measurements of signals received from devices in its proximity to the positioning entity or the network. From these LCS measurements, the positioning entity or the network can determine the relationship between the LCS and the GCS for the target device. The target device can report AoAs in its LCS and the positioning entity or network can convert to the GCS. Alternatively, the target device can request rotations α, β, and γ from the positioning entity or the network so that it can determine its orientation.

The positioning entity can use the rotation values to convert measurements from the target device in the LCS to the GCS. The converted GCS measurements can be used to establish an orientation of the target device in the GCS using LCS measurements, or to perform activities that benefit from knowing the orientation of the target device within the GCS.

Aspects of the present disclosure are described in the context of a wireless communications system. Aspects of the present disclosure are further illustrated and described with reference to device diagrams and flowcharts.

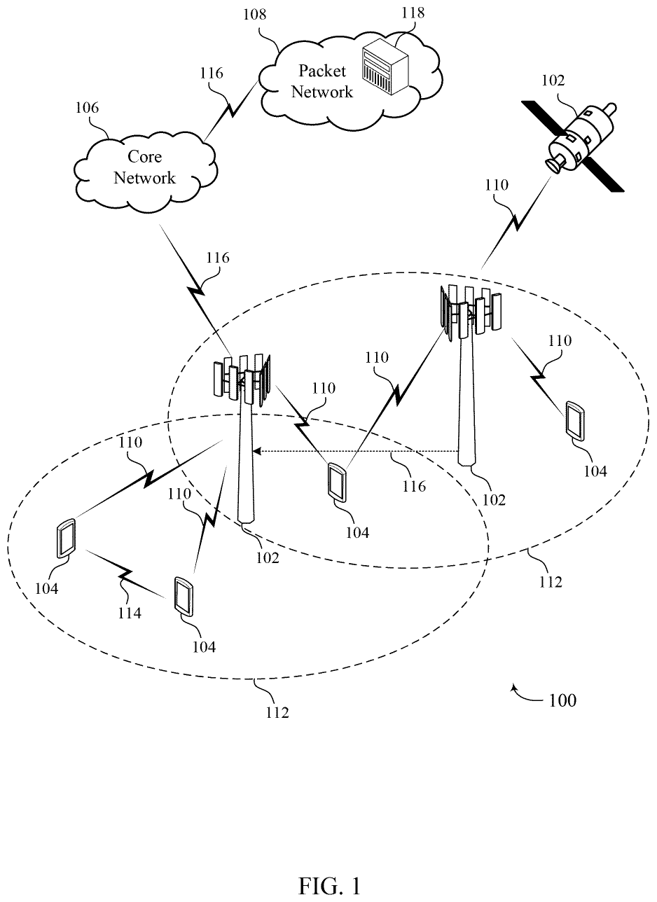

FIG. 1 illustrates an example of a wireless communications system 100 that supports determining the orientation of a local coordinate system relative to a global coordinate system in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be included or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. #Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHZ-114.25 GHZ), FR4a or FR4-1 (52.6 GHZ-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Positioning techniques supported in Rel-16 are listed in the following Table 1:

TABLE 1

| | | UE-assisted, | NG-RAN node | |
|---|---|---|---|---|
| Method | UE-based | LMF-based | assisted | SUPL |
| A-GNSS | Yes | Yes | No | Yes (UE-based |
| | | | | and UE-assisted) |
| OTDOA *, ** | No | Yes | No | Yes (UE-assisted) |
| E-CID *** | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS **** | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

* This includes TBS positioning based on PRS signals.
** In this version of the specification only OTDOA based on LTE signals is supported.
*** This includes Cell-ID for NR method.
**** In this version of the specification only for TBS positioning based on MBS signals.

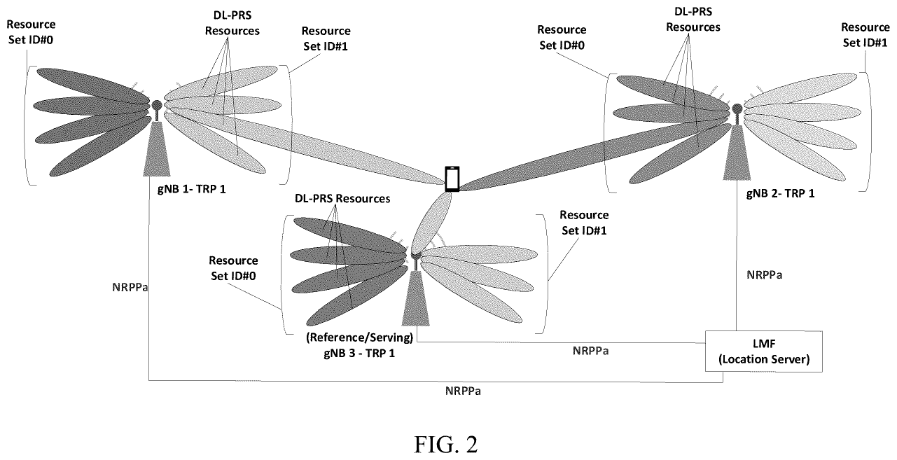

Separate positioning techniques as indicated in Table 1 can be configured and performed based on the requirements of the Location Management Function (LMF) and UE capabilities. The transmission of Uu (uplink and downlink) Positioning Reference Signals (PRS) enable the UE to perform UE positioning-related measurements to enable the computation of a UE's absolute location estimate and are configured per Transmission Reception Point (TRP), where a TRP may include a set of one or more beams. A conceptual overview is illustrated in FIG. 2.

The PRS can be transmitted by different base stations (serving and neighboring) using narrow beams over FR1 and FR2 as illustrated in FIG. 2, which is relatively different when compared to LTE where the PRS was transmitted across the whole cell. The PRS can be locally associated with a PRS Resource ID and Resource Set ID for a base station (TRP). Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

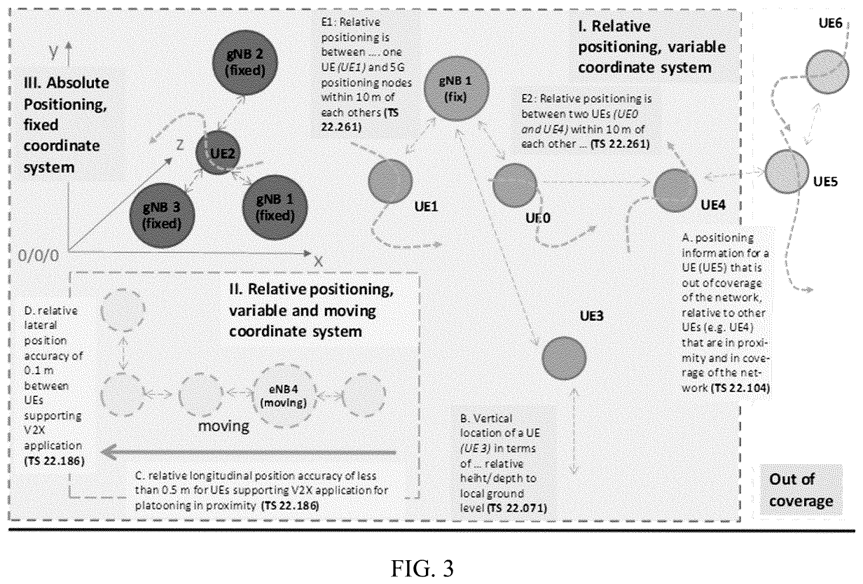

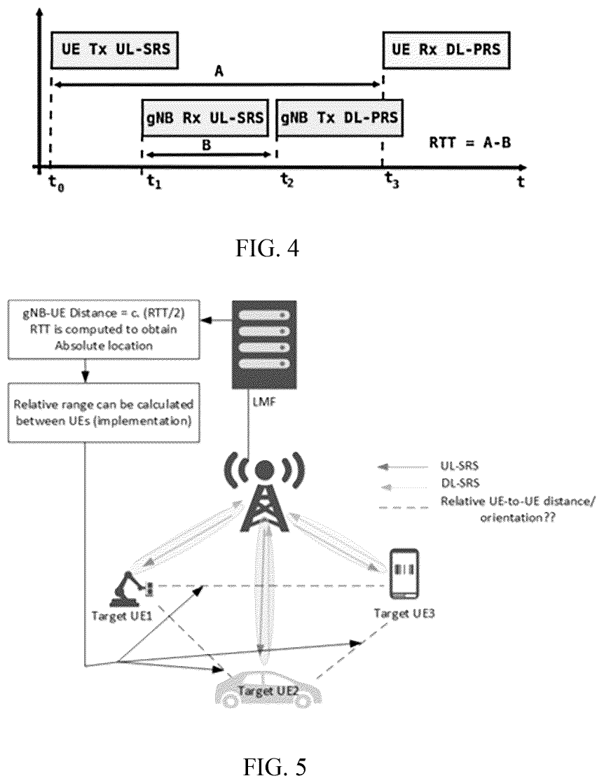

FIG. 3 is an overview of the absolute and relative positioning scenarios using three different co-ordinate systems: an Absolute Positioning, fixed coordinate system; a Relative Positioning, variable and moving coordinate systems; and a Relative Positioning, variable coordinate system. The following RAT-dependent positioning techniques may be used in embodiments of the present disclosure to support positioning of a target device.

Downlink Time Difference of Arrival (DL-TDOA) positioning makes use of the DL RSTD (and optionally DL PRS RSRP) of downlink signals received from multiple transmission points (TP) s, at the UE. The UE measures the DL RSTD (and optionally DL PRS RSRP) of the received signals using assistance data received from the positioning server, and the resulting measurements are used along with other configuration information to locate the UE in relation to the neighboring TPs.

Downlink Angle of Departure (DL AoD) positioning makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Multiple Round Trip Time (Multi-RTT) positioning uses UE reception and transmission (Rx-Tx) measurements and DL PRS RSRP of downlink signals received from multiple Transmission and Reception Points (TRP) s, measured by the UE and measured gNB Rx-Tx measurements and UL SRS-RSRP at multiple TRPs of uplink signals transmitted from UE.

The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server which are used to estimate the location of the UE (See FIG. 3). Multi-RTT is currently only supported for UE-assisted/NG-RAN assisted positioning techniques as noted in Table 1.

FIG. 5 illustrates an implementation-based approach to compute the relative distance between two UEs. This approach is high in latency and is not efficient in terms of procedures and signaling overhead.

For Enhanced Cell ID (CID) positioning, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (NR E CID) positioning refers to techniques which use additional UE measurements and/or NR radio resource and other measurements to improve the UE location estimate using NR signals.

Although NR E-CID positioning may utilize some of the same measurements as the measurement control system in the RRC protocol, the UE generally is not expected to make additional measurements for the sole purpose of positioning; the positioning procedures do not supply a measurement configuration or measurement control message, and the UE reports the measurements that it has available rather than being required to take additional measurement actions.

Uplink Time Difference of Arrival (UL TDOA) positioning makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

Uplink Angle of Arrival (UL AoA) positioning makes use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

In addition, several RAT-Independent positioning techniques are available, examples of which are described in TS38.305.

For example, Network-assisted GNSS techniques make use of UEs that are equipped with radio receivers capable of receiving GNSS signals. In 3GPP specifications the term GNSS encompasses both global and regional/augmentation navigation satellite systems. Examples of global navigation satellite systems include GPS, Modernized GPS, Galileo, GLONASS, and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services. Different GNSSs (e.g., GPS, Galileo, etc.) can be used separately or in combination to determine the location of a UE.

Barometric pressure sensor positioning makes use of barometric sensors to determine the vertical component of the position of the UE. The UE measures barometric pressure, optionally aided by assistance data, to calculate the vertical component of its location or to send measurements to the positioning server for position calculation. Barometric positioning is combined with other positioning methods to determine the 3D position of a UE.

Wireless Local Access Network (WLAN) positioning makes use of WLAN measurements (e.g. Access Point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE may use WLAN measurements and optionally WLAN AP assistance data provided by the positioning server, to determine its location.

Bluetooth positioning makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

A Terrestrial Beacon System (TBS) includes a network of ground-based transmitters, broadcasting signals for positioning purposes for TBS positioning. The current type of TBS positioning signals are the MBS (Metropolitan Beacon System) signals and Positioning Reference Signals (PRS). The UE measures received TBS signals, optionally aided by assistance data, to calculate its location or to send measurements to the positioning server for position calculation.

Motion sensor positioning makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method may be used with other positioning methods for hybrid positioning.

Table 2 and Table 3 show reference signal to measurements mapping for each of the supported RAT-dependent positioning techniques at the UE and gNB, respectively. RAT-dependent positioning techniques involve the 3GPP RAT and core network entities to perform the position estimation of the UE, which are differentiated from RAT-independent positioning techniques which rely on GNSS, IMU sensor, WLAN and Bluetooth technologies for performing target device (UE) positioning.

TABLE 2
UE measurements to enable RAT-dependent positioning techniques

| | | To facilitate support |
|---|---|---|
| DL/UL Reference | | of the following |
| Signals | UE Measurements | positioning techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS/ | UE Rx-Tx time | Multi-RTT |
| Rel. 16 SRS for | difference | |
| positioning | | |
| Rel. 15 SSB/CSI-RS | SS-RSRP(RSRP for | E-CID |
| for RRM | RRM), SS-RSRQ(for | |
| | RRM), CSI-RSRP (for | |
| | RRM), CSI-RSRQ (for | |
| | RRM), SS-RSRPB | |
| | (for RRM) | |

TABLE 3
gNB measurements to enable RAT-dependent positioning techniques

| | | To facilitate support |
|---|---|---|
| | | of the following |
| DL/UL Reference Signals | gNB Measurements | positioning techniques |
| Rel. 16 SRS for positioning | UL RTOA | UL-TDOA |
| Rel. 16 SRS for positioning | UL SRS-RSRP | UL-TDOA, UL-AoA, Multi-RTT |
| Rel. 16 SRS for positioning, | gNB Rx-Tx time | Multi-RTT |
| Rel. 16 DL PRS | difference | |
| Rel. 16 SRS for positioning | AoA and ZoA | UL-AoA, Multi-RTT |

Measurement and reporting are performed per configured RAT-dependent/RAT-independent positioning method. The RequestLocationInformation message body in an LTE Positioning Protocol (LPP) message is used by the location server to request positioning measurements or a position estimate from the target device, and The ProvideLocationInformation message body in a LPP message is used by the target device to provide positioning measurements or position estimates to the location server.

In addition, several RAT-dependent positioning measurements are available in cellular networks. Some of these techniques are detailed in the following Table 4:

TABLE 4
DL PRS reference signal received power (DL PRS-RSRP)

| | |
|---|---|
| Definition | DL PRS reference signal received power (DL PRS-RSRP), is the linear average |
| | over the power contributions (in [W]) of the resource elements that carry DL |
| | PRS reference signals configured for RSRP measurements within the |
| | considered measurement frequency bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than the |
| | corresponding DL PRS-RSRP of any of the individual receiver branches. |
| Applicable | RRC_CONNECTED intra-frequency, |
| for | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe received |
| | from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for the |
| | DL RSTD shall be the antenna of the UE. |
| Applicable | RRC_CONNECTED intra-frequency |
| for | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} measurement |
| | shall be the Tx antenna connector of the UE. For frequency range 2, the |
| | reference point for T_{UE-RX} measurement shall be the Rx antenna of the UE and |
| | the reference point for T_{UE-TX} measurement shall be the Tx antenna of the UE. |
| Applicable | RRC_CONNECTED intra-frequency |
| for | RRC_CONNECTED inter-frequency |

The present disclosure describes embodiments of an apparatus and method for relating the local coordinate system of a device to a global coordinate system. Devices which have the capability of measuring the angle of arrival of signals measure these angles in the local coordinate system of the device. If the device knows the relationship between the local coordinate system and a global coordinate system, then device can use these angles for positioning performed by the device, or these angles can be reported to a positioning entity and used by the positioning entity for positioning of the device. The location information may comprise one or more of the following data: orientation information, ranging in terms of distance, ranging in terms of direction, absolute and/or relative coordinate information, and absolute and/or relative altitudes.

A problem addressed by the present disclosure is how a device can determine the orientation of its local coordinate system, given by α, β, and γ, to the global coordinate system. One possible method for doing this is for the device to measure the angle of arrival of signals in the local coordinate system for which the angle of arrival in the global coordinate system is known. In some embodiments, this method is performed when the location of a UE (or other device) is known with some degree of accuracy but the orientation is unknown. For example, the location of the device may be determined using time difference of arrival or enhanced cell ID methods (the location accuracy required to accurately determine the device orientation will depend on the distance between the devices). Additionally, the UE has its own LCS relative to which it can measure the angles of arriving signals.

In an embodiment, the UE is in range of N other reference devices (UEs, gNBs, or other devices) for which the locations are known. If the locations of the UE and the N other devices are known, the line-of-sight angles of arrival of signals transmitted by these devices and received by the UE are known.

If the UE knows its own location and the location of the other N devices, then the UE can compute the line-of-sight angles of arrival in the global coordinate system. If the N devices (or a subset) know their own locations, they can signal their locations to the UE.

If the network knows the location of the UE and the other N devices, then the network can compute the angles of arrival in the global coordinate system and signal these angles to the UE. In another embodiment, the network signals the locations of these other devices to the UE and the UE computes the angles of arrival.

In some embodiments, at least three AOA measurements (in LCS) of signals from devices with known AoAs in the GCS are used to determine the orientation of the LCS relative to the GCS. The UE measures the angles of arrival in the local coordinate system, which involves the use of at least one two-dimensional linear array. If the patterns of the antenna elements within the array do not provide adequate spherical coverage (due to the nature of the radiating element or alternatively due to blocking by the device itself), then a two-dimensional linear array may be used on each side of the device.

Some devices can define a local coordinate system relative to which the devices can form beams for transmission and reception. In many cases it is desirable for the device to determine the orientation of the local coordinate system with respect to a global coordinate system. For example, this information may be used by the device to correctly report to the network or other positioning entity the direction and range of other devices relative to itself.

For handheld devices, the precise orientation of the device LCS to the GCS may be largely unknown. Conversely, for vehicular mounted device some information concerning the relationship of the LCS to the GCS may be available. For example, it may be possible to assume that the horizontal plane is the same for the LCS and the GCS. For other cases, other assumptions may apply.

In some cases, the angle of arrival of signals received by a device may be used to assist in determining the location of that device. In some cases, the angle of arrival of signals received by the device may be used to assist in determining the location of other devices. In some cases, there is value in knowing the orientation of a device that is independent of location services.

In embodiments of the present disclosure, the position of the device is known in a common coordinate system (e.g., a Euclidean coordinate system) with some degree of accuracy. In addition, it is assumed that there are N other devices that are hearable by the device for which the positions are known in the same coordinate system. By using the knowledge of the device location and the location of the N other devices, line-of-sight angles of the signals received from the N other devices can be determined in the global coordinate system. If the device can measure the angle of arrival of the signals received from these same N devices in its local coordinate system, the relationship between the local coordinate system and the global coordinate system can be established.

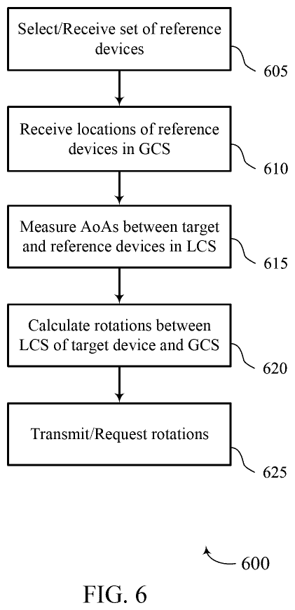

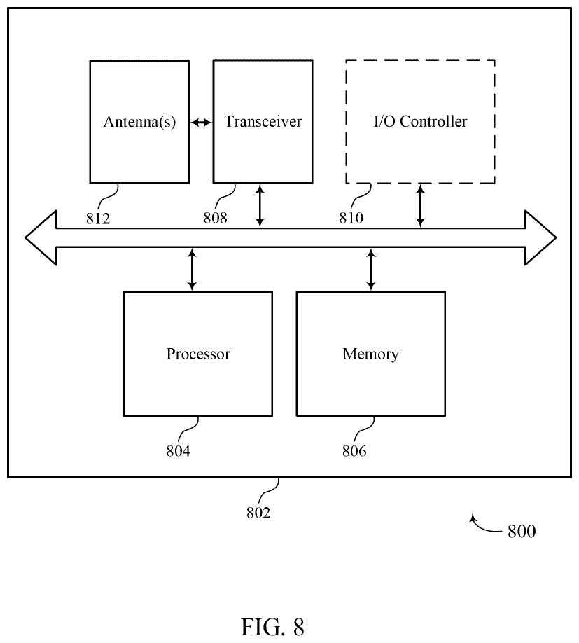

FIG. 6 illustrates a flowchart of a method 600 that supports determining the orientation of a local coordinate system relative to a global coordinate system in accordance with aspects of the present disclosure. The operations of the method 600 may be implemented by a device or its components as described herein. For example, the operations of the method 600 may be performed by a UE 104 as described with reference to FIGS. 1 and 8. In some implementations, the device may execute a set of instructions to control the function elements of the device to perform the described functions. Additionally, or alternatively, the device may perform aspects of the described functions using special-purpose hardware.

In some embodiments, a method 600 may be performed when an initiator device, which may be a network entity, (e.g., gNB or LMF) or a UE or roadside unit (RSU), initiates a sidelink positioning or ranging session. Session initiation may be acknowledged when a responder device responds to the sidelink positioning or ranging session request. The responder device may be a network entity such as a gNB or LMF, or a UE or roadside unit (RSU).

Sidelink positioning may include positioning a UE using reference signals transmitted over a sidelink channel, e.g. the PC5 interface, to obtain absolute position, relative position, or ranging information. Ranging may include determining the distance between a UE and another entity within the network, such as an anchor UE. An anchor UE may be a UE that supports positioning of a target UE, for example, by transmitting and/or receiving reference signals for positioning, providing positioning-related information, etc., over a SL interface.

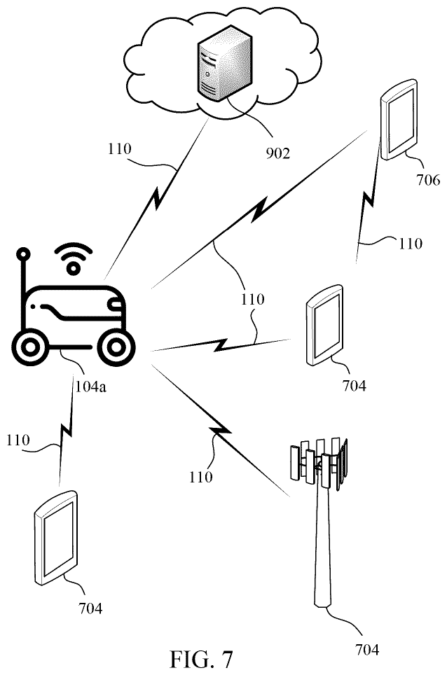

FIG. 7 illustrates an example of a target device 104a and three reference devices 704 that supports determining the orientation of a local coordinate system relative to a global coordinate system in accordance with aspects of the present disclosure.

The target device 104a communicates with the reference devices 704 using communication links 110. When the reference devices are UEs, the communication link 110 may be a sidelink, and when the reference device is a base station, the communication link may be another signal such as a reference signal, baseband signal, or other wireless communication link. In addition, the target device 104a may communicate with a positioning entity 902 and an assistant UE 706.

The positioning entity 902 may be a computing device that operates a positioning network function such as a location management function (LMF). In another embodiment, the positioning entity is a sidelink positioning server UE, which may be a UE offering location calculations for sidelink positioning and ranging based services. A sidelink positioning server UE may interact with other UEs over PC5 to calculate the location of a target UE. A target UE or SL Reference UE can act as SL Positioning server UE if location calculations are supported.

Another device that may participate in embodiments of the present disclosure is an assistant UE 706. An assistant UE 706 is a UE that supports ranging in sidelink between a SL reference UE 704 and target UE 104a over PC5, and may be used when direct ranging or sidelink positioning between a reference UE 704 or anchor UE and the target UE 104a is not supported. The results of ranging or sidelink positioning between an assistant UE 706 and reference UE 704 and between the assistant UE 706 and the target UE 104a may be used to derive the positioning results between a target UE 104a and reference UE 704.

Another device that may participate in embodiments of the present disclosure is a sidelink positioning node, which may be a network entity and/or device/UE participating in a SL positioning session, e.g., LMF (location server), gNB, UE, RSU, anchor UE, initiator and/or responder UE. Still another device is a configuration entity, which is a network node or UE capable of configuring time-frequency resources and related SL positioning configurations.

FIG. 8 illustrates an example of a block diagram 800 of a device 802 that supports determining the orientation of a local coordinate system relative to a global coordinate system in accordance with aspects of the present disclosure. The device 802 may be an example of a UE 104 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. Processor 804 may be configured as or otherwise support a means for measuring AoA values in the LCS and calculating rotation values.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

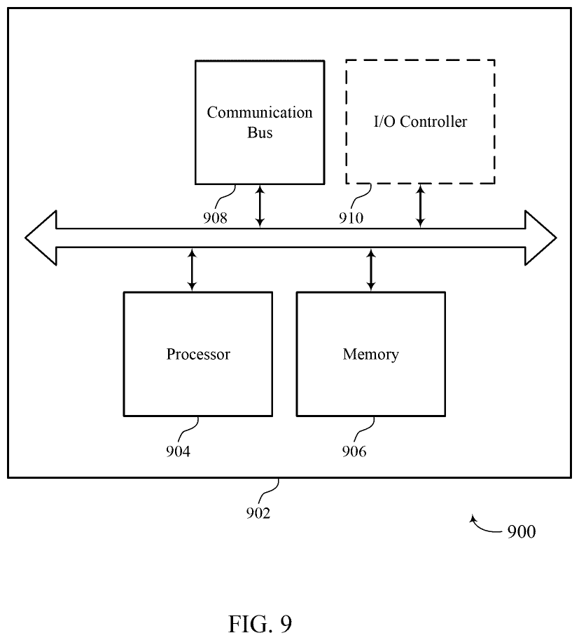

FIG. 9 illustrates an example of a block diagram 900 of a device 902 that supports determining the orientation of a local coordinate system relative to a global coordinate system in accordance with aspects of the present disclosure. The device 902 may be an example of a positioning entity as described herein. The device 902 may support wireless communication with one or more network entities 102, UEs 104, or any combination thereof. The device 902 may include components for bi-directional communications including components for transmitting and receiving communications, such as a processor 904, a memory 906, a communication bus 908, and an I/O controller 910. These components may be in electronic communication or otherwise coupled (e.g., operatively, communicatively, functionally, electronically, electrically) via one or more interfaces (e.g., buses).

The processor 904, the memory 906, the communication bus 908, or various combinations thereof or various components thereof may be examples of means for performing various aspects of the present disclosure as described herein. For example, the processor 904, the memory 906, the communication bus 908, or various combinations or components thereof may support a method for performing one or more of the operations described herein.

In some implementations, the processor 904, the memory 906, the communication bus 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. Processor 904 may be configured as or otherwise support a means for determining the orientation of a local coordinate system relative to a global coordinate system.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The communication bus 908 may facilitate communication between the positioning entity 902 and other network components. For example, the communication bus 908 may facilitate communication between the positioning entity 902 and a network entity 102 such as a gNB that is in wireless communication with a target device 104a and a plurality of reference devices 704.

Although not illustrated in FIG. 9, in some embodiments, positioning entity 902 is a network device or UE that manages a location function, or has location functionality apart from an LMF. In such an embodiment, the positioning entity 902 may have an antenna and transceiver as illustrated and described with respect to the device 802 of FIG. 8. A positioning entity 902 that is a UE may be referred to as a location server UE.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor 904. In some implementations, a user may interact with the device 902 via the I/O controller 910 or via hardware components controlled by the I/O controller 910.

Returning to FIGS. 6 and 7 and method 600, a target device 104a may be a UE of interest whose position (absolute or relative) is to be obtained by the network or by the UE itself. Although the target device 104a illustrated in FIG. 7 is a vehicle, the target device may be any UE, including a handheld device. The reference devices 704 may be UEs, gNBs, or other network devices with wireless communication capability. In an embodiment, reference devices 704 are UEs that are used to determine reference planes and/or reference directions for ranging and positioning services. In some embodiments, one or more assistant UE provides assistance for ranging/sidelink positioning when the direct ranging/sidelink positioning between a reference UE 704 and a target UE 104a is not supported or otherwise feasible.

At 605, the method may include selecting or receiving a set of reference devices 704. The operations of 605 may be performed in accordance with examples as described herein. In some implementations, aspects of the operations of 605 may be performed by a device as described with reference to FIG. 1.

In an embodiment, selecting reference devices includes selecting three reference devices whose locations are known, and these reference devices may be used in conjunction with a target device to determine rotations between an LCS of the target device and a GCS.

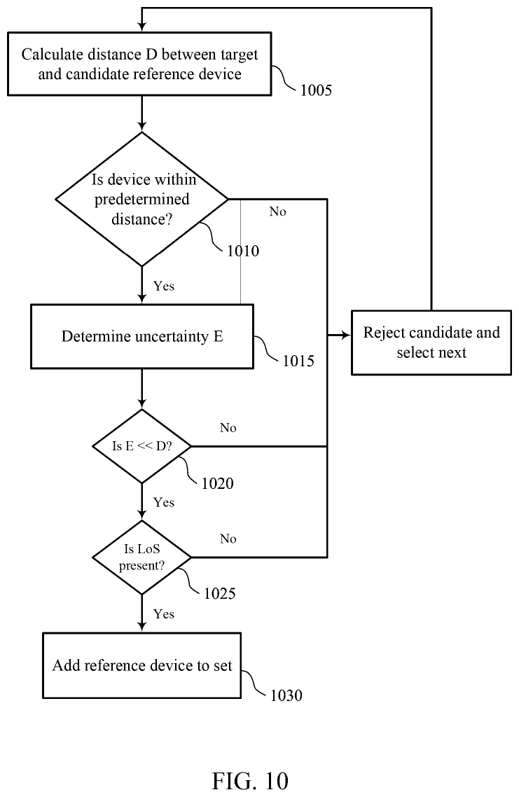

FIG. 10 illustrates a flowchart of a method 1000 for selecting a set of reference devices according to 605 of method 600. The operations of the method 1000 may be implemented by a device or its components as described herein. For example, the operations of the method 1000 may be performed by a network device 102 such as a positioning entity 902 or a UE 104 as described with reference to FIGS. 1, 8 and 9. In some implementations, the device may execute a set of instructions to control the function elements of the device to perform the described functions. Additionally, or alternatively, the device may perform aspects of the described functions using special-purpose hardware.

In an embodiment, the initial pool of candidate devices for method 1000 may be UEs with a sidelink RSSI (S-RSSI) value with respect to the target UE 104a that is above a threshold. In another embodiment, candidate devices are UEs within a predetermined distance of target UE 104a. In other embodiments, the initial pool may be, for example, UEs that are served by the same cell or are served by the same base station as target UE 104a, UEs that are within a certain area, etc.

At 1005, the method may include calculating a distance D between the target device 104a and a candidate reference device 104c. The operations of 1005 may be performed in accordance with examples as described herein. In some implementations, aspects of the operations of 1005 may be performed by a device as described with reference to FIG. 1.

At 1010, the method may include comparing the distance D between the target UE 104a and the candidate UE 704. The operations of 1010 may be performed in accordance with examples as described herein. In some implementations, aspects of the operations of 1010 may be performed by a device as described with reference to FIG. 1.

If the distance D is greater than the threshold, then the candidate UE may be rejected because the received signal strength may be low so that the quality of the angle of arrival measurement is poor. Examples of the threshold distance are 300 meters, 500 meters, and 1000 meters. In some embodiments, such as when S-RSSI values are used to select candidates, 1010 may be omitted. The distance threshold may be configured by the network using a variety of options of network signalling including DCI, DL MAC CE, RRC, LPP signaling, e.g., Provide Assistance Data or RequestLoctationInformation messages or combinations thereof. The distance threshold may be configured with a UE, i.e., based on a pre-configuration. The distance thresholds may also be exchanged between UEs using PC5 RRC signalling, new SL Positioning Protocol (SLPP/RSPP), e.g., SLPP/RSPP ProvideLocationInformation message or SLPP/RSPP ProvideAssistanceData message or combinations thereof. The distance thresholds may also be provided based on a prior request using the one or more of the aforementioned signalling options. The distance threshold may also be configured as a set of triggered events, wherein each event may have a different distance threshold.

At 1015, the method may include determining an uncertainty for the location of the candidate UE 104c. The operations of 1015 may be performed in accordance with examples as described herein. In some implementations, aspects of the operations of 1015 may be performed by a device as described with reference to FIG. 1.

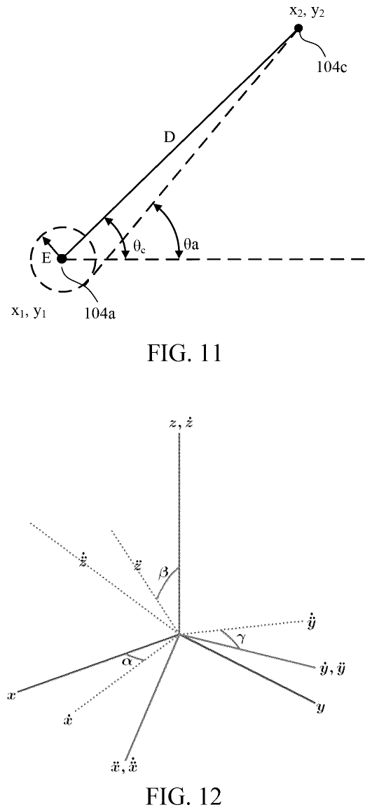

The location of a device need not be known exactly to determine line-of-sight angle of arrival of signals in the global coordinate system. The location accuracy that is effective depends on the distance D between the target device 104a and each reference device 704 as illustrated in FIG. 11.

In some embodiments, the uncertainty is based on the technique used to determine a device's position, in which case determining an uncertainty at 1015 may be performed, for example, by choosing an uncertainty value E from a lookup table. In some embodiments, the maximum magnitude of the uncertainty value E may be determined or refined based on network data such as the amount of noise present when measuring a position using a signaling technique.

In various embodiments, the approximate location of a device may be obtained using a variety of methods, e.g., E-CID (enhanced cell ID techniques) applicable for both Uu and SL interfaces, Uu and/or SL received signal strength (RSS) measurement metrics corresponding to the Uu and/or SL positioning reference signal(s) or other RSS measurements based on other signals or channels such as SSB, SL-SSS, CSI-RS or SL CSI-RS, PSBCH RSRP, PSSCH RSRP, PSCCH RSRP, SL RSSI.

In the following discussion, D is the distance between the target device and a candidate reference device for which the location is known, and uncertainty in the location of the target device is E. Based on the estimated location of the target device, the angle of arrival in the global coordinate system is computed as θ_{c}. For a target device at location (x₁, y₁) and a second device at (x₂, y₂), the distance D is given by

$$D = \sqrt{{( {x}_{2} - {x}_{1} )}^{2} + {( {y}_{2} - {y}_{1} )}^{2}}$$

The angle θ_{c} can be computed as

$${θ}_{c} = {sin}^{- 1} ( \frac{{y}_{2} - {y}_{1}}{{x}_{2} - {x}_{1}} )$$

If the uncertainty in the location of the target device has radius E, then the worst-case error in the computation of the angle θ_{c} can be determined. If we define

$$Δ x = E sin {θ}_{c} Δ y = - E cos {θ}_{c}$$

then the measured angle of arrival is given by

$${θ}_{a} = {sin}^{- 1} ( \frac{{y}_{2} - ( {y}_{1} + Δ y )}{\sqrt{{( {x}_{2} - ( {x}_{1} + Δ x ) )}^{2} + {( {y}_{2} - ( {y}_{2} + Δ y ) )}^{2}}} ) = {sin}^{- 1} ( \frac{D sin {θ}_{c} + E cos {θ}_{c}}{\sqrt{{( D cos {θ}_{c} - E sin {θ}_{c} )}^{2} + {( D sin {θ}_{c} + E cos {θ}_{c} )}^{2}}} ) = {sin}^{- 1} ( \frac{sin {θ}_{c} + ( E / D ) cos {θ}_{c}}{\sqrt{1 + {( E / D )}^{2}}} ) = {sin}^{- 1} ( sin {θ}_{c} + \frac{sin {θ}_{c} ( 1 - \sqrt{1 + {Δ}^{2}} ) + Δ cos {θ}_{c}}{\sqrt{1 + {Δ}^{2}}} )$$

where Δ=E/D. Using the fact that

$$\sqrt{1 + x} \leq 1 + \frac{x}{2}$$

it follows that

$$\vert \frac{sin {θ}_{c} ( 1 - \sqrt{1 + {Δ}^{2}} ) + Δ cos {θ}_{c}}{\sqrt{1 + {Δ}^{2}}} \vert \leq \vert \frac{sin {θ}_{c} ( \sqrt{1 + {Δ}^{2}} - 1 )}{\sqrt{1 + {Δ}^{2}}} \vert + \vert \frac{Δ cos {θ}_{c}}{\sqrt{1 + {Δ}^{2}}} \vert \leq \frac{{Δ}^{2}}{2} \vert sin {θ}_{c} \vert + Δ \vert cos {θ}_{c} \vert$$

The derivative of the inverse sine function is given by

$${( {sin}^{- 1} x )}^{′} = \frac{1}{\sqrt{1 - {x}^{2}}} .$$

When evaluated at sin θ_{c}, the derivative is given by

$$\frac{1}{\sqrt{1 - {sin}^{2} {θ}_{c}}} = \frac{1}{cos {θ}_{c}} .$$

Thus, the maximum magnitude of the angle measurement error is approximately

$$\vert {θ}_{c} - {θ}_{a} \vert \leq \vert \frac{1}{cos {θ}_{c}} \vert ( \frac{{Δ}^{2}}{2} \vert sin {θ}_{c} \vert + Δ \vert cos {θ}_{c} \vert ) = \frac{{Δ}^{2}}{2} \vert tan {θ}_{c} \vert + Δ$$

In the case that |tan θ_{c}|≤1, the maximum magnitude of the error is approximately

$$\vert {θ}_{c} - {θ}_{a} \vert \leq \frac{{Δ}^{2}}{2} + Δ \approx Δ$$

To address the case that |tan θ_{c}|≥1, it can be noted that

$${θ}_{a} = {cos}^{- 1} ( \frac{{x}_{2} - ( {x}_{1} + Δ x )}{\sqrt{{( {x}_{2} - ( {x}_{1} + Δ x ) )}^{2} + {( {y}_{2} - ( {y}_{2} + Δ y ) )}^{2}}} )$$

$$= {cos}^{- 1} ( \frac{D cos {θ}_{c} - E sin {θ}_{c}}{\sqrt{{( D cos {θ}_{c} - E sin {θ}_{c} )}^{2} + {( D sin {θ}_{c} + E cos {θ}_{c} )}^{2}}} )$$

$$= {cos}^{- 1} ( \frac{cos {θ}_{c} - ( E / D ) sin {θ}_{c}}{\sqrt{1 + {( E / D )}^{2}}} )$$

$$= {cos}^{- 1} ( cos {θ}_{c} + \frac{cos {θ}_{c} ( 1 - \sqrt{1 + {Δ}^{2}} ) + Δ sin {θ}_{c}}{\sqrt{1 + {Δ}^{2}}} )$$

Using the fact that

$$\sqrt{1 + x} \leq 1 + \frac{x}{2}$$

it follows that

$$\vert \frac{cos {θ}_{c} ( 1 - \sqrt{1 + {Δ}^{2}} ) + Δ sin {θ}_{c}}{\sqrt{1 + {Δ}^{2}}} \vert \leq \vert \frac{cos {θ}_{c} ( \sqrt{1 + {Δ}^{2}} - 1 )}{\sqrt{1 + {Δ}^{2}}} \vert + \vert \frac{Δ sin {θ}_{c}}{\sqrt{1 + {Δ}^{2}}} \vert \leq \frac{{Δ}^{2}}{2} \vert cos {θ}_{c} \vert + Δ \vert sin {θ}_{c} \vert$$

The derivative of the inverse cosine function is given by

$${( {cos}^{- 1} x )}^{′} = \frac{- 1}{\sqrt{1 - {x}^{2}}} .$$

When evaluated at cos θ_{c}, the derivative is given by

$$\frac{- 1}{\sqrt{1 - {cos}^{2} {θ}_{c}}} = \frac{- 1}{sin {θ}_{c}} .$$

Thus, the maximum magnitude of the angle measurement error is approximately

$$\vert {θ}_{c} - {θ}_{a} \vert \leq \vert \frac{1}{sin {θ}_{c}} \vert ( \frac{{Δ}^{2}}{2} \vert cos {θ}_{c} \vert + Δ \vert sin {θ}_{c} \vert ) = \frac{{Δ}^{2}}{2} \vert cot {θ}_{c} \vert + Δ$$

In the case that |tan θ_{c}|≥1, it follows that |cot θ_{c}|≤1 and the maximum magnitude of the error is approximately

$$\vert {θ}_{c} - {θ}_{a} \vert \leq \frac{{Δ}^{2}}{2} + Δ \approx Δ .$$

Thus, regardless of the magnitude of |tan θ_{c}|, the maximum magnitude of the angle measurement error is approximately

$$\vert {θ}_{c} - {θ}_{a} \vert \approx Δ .$$

To limit the measurement error to Z degrees, it follows that

$$\frac{E}{D} = Δ \leq Z \frac{2 π}{360} = 0.0175 \cdot Z$$

so that

$$\frac{E}{D} \leq 0.0175 \cdot Z .$$

At 1020, the method may include comparing the uncertainty value for the location of the candidate UE 104c to the distance D to the target UE 104a. The operations of 1020 may be performed in accordance with examples as described herein. In some implementations, aspects of the operations of 1020 may be performed by a device as described with reference to FIG. 1. An example of threshold ratios between the uncertainty E and distance D are 0.018, 0.034, 0.053, 0.070, and 0.088 in order for the accuracy of the computed angle to be less than or equal to 1, 2, 3, 4, and 5 degrees, respectively. The accuracy of the computed angle will then affect the accuracy of the determined device orientation.

If the positioning uncertainty is much less than the distance D to a reference device 704 used to determine the target device 104a orientation, the location of the target device need not be known with high accuracy to effectively determine the angle of arrival in the global coordinate system. For this reason, it may be beneficial to use devices which are far away from the target device when determining the device orientation. Accordingly, in some embodiments, candidate devices that are less than a predetermined distance from the target device may be rejected for use as reference devices.

A target device 104a location accuracy to distance D conditional mapping may be configured to either the target device 104a or candidate device to ascertain if an initial location accuracy should be known with high or low precision.

In some embodiments, the relationship between positioning uncertainty E and distance D (e.g., mapping between both positioning uncertainty E and distance D) may be configured as an event-based threshold to either the target device 104a or a candidate device to initiate procedures to determine the orientation of the target device with respect to another device or vice versa. In other words, if the pair of devices, a target device and a candidate device, are within a distance D with a determined positioning uncertainty E, the device orientation may be computed. The distance D may correspond to the Euclidean distance between the devices as mentioned above.

The configuration of the positioning uncertainty E and distance D may originate from another configuration entity such as a base station or location server via RRC, DL MAC CE, LPP signaling or pre-configured within the device itself. In a further implementation, D may also be updated dynamically or semi-statically based on UE-specific signaling or system information broadcast signaling. In another implementation such a configuration of both parameters may be configured by another device via a SL interface using SL MAC CE, PC5 RRC or SL Positioning Protocol configuration signaling, e.g., SL positioning assistance data.

At 1025, the method may include determining whether a line of sight is present between the candidate device and the target UE 104a. The operations of 1025 may be performed in accordance with examples as described herein. In some implementations, aspects of the operations of 1025 may be performed by a device as described with reference to FIG. 1.

In some embodiments, the presence of a line of sight may be assumed based on the condition of sidelink signaling between the target UE 104a and candidate device, for example by comparing an S-RSSI value to a threshold. In another embodiment, the presence of a line of sight may be configured for a given set of devices, or 1025 may be skipped.

The presence of absence of line of sight may be designated by a binary indicator, e.g. 0 for LOS and 1 for no LOS. Since it may not always be possible to determine whether LOS is present with certainty, the presence of a line of sight may be estimated as a probability at 1025. For example, the probability of a line of sight being present may be indicated by a value between 0 and 1, where 0 is the lowest probability that a line of sight is present, and 1 is the highest probability that a line of sight is present. The probability values may be used in later processes, e.g. to select which reference devices are used for subsequent steps of method 600.

In still another embodiment, method 600 may be performed for multiple sets of reference UEs 704, the resulting rotations for each set of reference UEs 704 are compared to each other, and devices associated with rotations that are similar to other rotations are determined to have line of sight relationships with the target device 104a. For example, if M candidate devices 704 are present, method 600 may be performed for multiple sets of three candidate devices such that each candidate device is included in two or three different sets. If all the sets in which a given candidate device deviate substantially from rotation values associated with other sets, then the given candidate device is determined to lack line of sight with the target device at 1025.

This process of calculating rotations for multiple sets of reference devices may be performed independent of a LOS determination at 1025 to increase confidence in the accuracy of rotation values. In some embodiments, rotation values for different sets of devices that are within a predetermined range of one another are averaged.

At 1030, the method may include adding the candidate reference device to a set of reference devices that may be used to orient the target device. The operations of 1030 may be performed in accordance with examples as described herein. In some implementations, aspects of the operations of 1030 may be performed by a device as described with reference to FIG. 1.

Otherwise, if the candidate device fails to meet selection criteria at 1010, 1020 or 1025, the candidate device may be rejected for inclusion in the set of reference devices. Method 1000 may be performed for all devices within a certain range of the target devices.

In some embodiments, after a set of reference devices is established, one, two, three or more devices may be chosen from the set for subsequent steps of method 600 described below. In some embodiments, when the set includes more devices than necessary, the specific devices that are used for method 600 are chosen based on a criteria such as distance to the target, ratio between distance and uncertainty, presence of line of sight, confidence in line of sight determination, sidelink signal strength, the type of device, etc. In some embodiments, various combinations of devices are used to calculate rotation values, outlier values are discarded, and non-outlier values may be averaged.

Returning to FIG. 6, after a set of reference devices is selected at 605, the device performing method 600 receives the locations of one or more reference device at 610. The operations of 610 may be performed in accordance with examples as described herein. In some implementations, aspects of the operations of 610 may be performed by a device as described with reference to FIG. 1.

A network device such as a positioning entity 902 may calculate angle of arrival values between the target device 104a and the reference devices 704 within the global coordinate system. The positioning entity 902 may use positions of the devices within the GCS to calculate the GCS AoAs using those positions. For example, the location of the devices could be determined using time difference of arrival, enhanced cell ID methods, or other methods as described above. After the GCS AoAs are calculated, those values may be received by the entity performing method 600, e.g. a target device.

At 615, the method may include measuring angles of arrival between target and reference devices in the local coordinate system. The operations of 615 may be performed in accordance with examples as described herein. In some implementations, aspects of the operations of 615 may be performed by a device as described with reference to FIG. 1.

In an embodiment, the target device measures signals received from the reference devices to measure the LCS AoAs. For example, the target device 104a may receive signals over a sidelink channel from the reference devices 704 and measure the angle of arrival for those sidelink signals within the LCS of the target device.

As will be discussed subsequently, the device measurement of the angle of arrivals in the local coordinate system can be combined with knowledge of the of the angle of arrivals in the global coordinate system to determine the orientation of the device and the relationship between the local coordinate system and the global coordinate system.

At 620, the method may include calculating rotations between the LCS of the target device and the GCS. The operations of 620 may be performed in accordance with examples as described herein. In some implementations, aspects of the operations of 620 may be performed by a device as described with reference to FIG. 1.

In general, the relationship between the LCS and GCS can be expressed in terms of three rotation angles as illustrated in FIG. 12. The transformation of Cartesian LCS coordinates (x,y,z) into GCS coordinates [symbol] is given by

$$[ \begin{matrix}{x}^{…} \\ {y}^{…} \\ {z}^{…}\end{matrix} ] = R [ \begin{matrix}x \\ y \\ z\end{matrix} ]$$

where

$$R = {R}_{Z} ( α ) {R}_{Y} ( β ) {R}_{X} ( γ ) = [ \begin{matrix}+ cos α & - sin α & 0 \\ + sin α & + cos α & 0 \\ 0 & 0 & 1\end{matrix} ] [ \begin{matrix}+ cos β & 0 & + sin β \\ 0 & 1 & 0 \\ - sin β & 0 & + cos β\end{matrix} ] [ \begin{matrix}1 & 0 & 0 \\ 0 & + cos γ & - sin γ \\ 0 & + sin γ & + cos γ\end{matrix} ] = [ \begin{matrix}cos α cos β & cos α sin β sin γ - sin α cos γ & cos α sin β cos γ + sin α sin γ \\ sin α cos β & sin α sin β sin γ + cos α cos γ & sin α sin β cos γ - cos α sin γ \\ - sin β & cos β sin γ & cos β cos γ\end{matrix} ]$$

R may be a unitary matrix so that the rows and columns are unitary and orthogonal.

Devices D₁, D₂ and D₃ have angles of arrival in the global coordinate system given by (θ₁, φ₁), (θ₂, φ₂), and (θ₃, φ₃) where θᵢ denotes the azimuth and φᵢ denotes the declination relative to vertical. These angles can be converted into unit vectors uᵢ=(xᵢ, yᵢ, zᵢ)^{T} in the global coordinate system with the mapping

$${x}_{i} = cos ( {θ}_{i} ) sin ( {ϕ}_{i} )$$

$${y}_{i} = sin ( {θ}_{i} ) sin ( {ϕ}_{i} )$$

$${z}_{i} = cos ( {ϕ}_{i} )$$

The angle of arrivals of these same signals in the local coordinate system are given by (θ′₁, φ′₁), (θ′₂, φ′₂), and (θ′₃, φ′₃). These angles are then converted to unit vectors

$$( {θ}_{1}^{′} , {ϕ}_{1}^{′} ) , ( {θ}_{2}^{′} , {ϕ}_{2}^{′} ) , and ( {θ}_{3}^{′} , {ϕ}_{3}^{′} ) .$$

in the local coordinate system with the mapping

$${{x}^{…}}_{i} = cos ( {θ}_{i}^{′} ) sin ( {ϕ}_{i}^{′} )$$

$${{y}^{…}}_{i} = sin ( {θ}_{i}^{′} ) sin ( {ϕ}_{i}^{′} )$$

$${{z}^{…}}_{i} = cos ( {ϕ}_{i}^{′} {ϕ}_{i} )$$

The matrices U and

[symbol]

are defined as

$$U = [ \begin{matrix}{u}_{1} & {u}_{2} & {u}_{3} ] ,\end{matrix}$$

$$and$$

$${U}^{…} = [ \begin{matrix}{{u}^{…}}_{1} & {{u}^{…}}_{2} & {{u}^{…}}_{3} ] ,\end{matrix}$$

from which it follows that

$${U}^{…} = R U .$$

If the matrix U has full rank, then an estimate of the matrix R can be computed as

$$\hat{R} = {U}^{…} {U}^{- 1}$$

Since the matrix R can be expressed as

$$R = [ \begin{matrix}cos α cos β & cos α sin β sin γ - sin α cos γ & cos α sin β cos γ + sin α sin γ \\ sin α cos β & sin α sin β sin γ + cos α cos γ & sin α sin β cos γ - cos α sin γ \\ - sin β & cos β sin γ & cos β cos γ\end{matrix} ] ,$$

it follows that estimates of the values of α, β, and γ can be computed from \hat{R}.

The angles used for the Euler rotations can be defined to have values in the following ranges:

$$0 \leq α , γ < 2 π$$

$$- \frac{π}{2} \leq β < \frac{π}{2} .$$

One possible solution to this set of equations is given by

$${\hat{R}}_{31} = - sin \hat{β} ⇒ \hat{β} = {sin}^{- 1} ( - {\hat{R}}_{31} )$$

where here the inverse sine is defined to be in the range [−π/2, π/2]. Because the inverse sine is only defined for the domain [−1,1], the argument −\hat{R}₃₁ must be limited to this domain. For this reason, we can define

$${\overline{\hat{R}}}_{31} = \{ \begin{matrix}{\hat{R}}_{31} & - 1 \leq {\hat{R}}_{31} \leq 1 \\ - 1 & {\hat{R}}_{31} < - 1 \\ 1 & {\hat{R}}_{31} > 1\end{matrix} .$$

so that

$$\hat{β} = {sin}^{- 1} ( - {\overline{\hat{R}}}_{31} ) .$$

Following this, we have

$$cos \hat{β} ⇒ cos ( {sin}^{- 1} ( - {\overline{\hat{R}}}_{31} ) ) .$$

$$sin \hat{γ} = \frac{{\hat{R}}_{32}}{cos \hat{β}} = \frac{{\hat{R}}_{32}}{cos ( {sin}^{- 1} ( - {\overline{\hat{R}}}_{31} ) )}$$

$$cos \hat{γ} = \frac{{\hat{R}}_{33}}{cos \hat{β}} = \frac{{\hat{R}}_{33}}{cos ( {sin}^{- 1} ( - {\overline{\hat{R}}}_{31} ) )}$$

$$sin \hat{α} = \frac{{\hat{R}}_{21}}{cos \hat{β}} = \frac{{\hat{R}}_{21}}{cos ( {sin}^{- 1} ( - {\overline{\hat{R}}}_{31} ) )}$$

$$cos \hat{α} = \frac{{\hat{R}}_{11}}{cos \hat{β}} = \frac{{\hat{R}}_{11}}{cos ( {sin}^{- 1} ( - {\overline{\hat{R}}}_{31} ) )} .$$

If we define the inverse tangent to be in the range [0, π], then we can define γ as

$$\hat{γ} = \{ \begin{matrix}{tan}^{- 1} ( \frac{{\hat{R}}_{32}}{{\hat{R}}_{33}} ) & cos ( \hat{γ} ) \geq 0 \\ {tan}^{- 1} ( \frac{{\hat{R}}_{32}}{{\hat{R}}_{33}} ) + π & cos ( \hat{γ} ) < 0\end{matrix} ,$$

or equivalently,

$$\hat{γ} = \{ \begin{matrix}{tan}^{- 1} ( \frac{{\hat{R}}_{32}}{{\hat{R}}_{33}} ) & \frac{{\hat{R}}_{33}}{cos ( {sin}^{- 1} ( - {\hat{R}}_{31} ) )} \geq 0 \\ {tan}^{- 1} ( \frac{{\hat{R}}_{32}}{{\hat{R}}_{33}} ) + π & \frac{{\hat{R}}_{33}}{cos ( {sin}^{- 1} ( - {\hat{R}}_{31} ) )} < 0\end{matrix} .$$

It can be noted that the \hat{γ} can also be defined in terms of the inverse cosine or inverse sine, but in these cases the arguments must be limited to the interval [1,1] as was the case in solving for \hat{β}. By using the inverse tangent to define \hat{γ}, there is no limitation on the argument since the domain of the inverse tangent is (−∞, ∞). However, either of these definitions can be used.

Similarly, for \hat{α} we have

$$\hat{α} = \{ \begin{matrix}{tan}^{- 1} ( \frac{{\hat{R}}_{21}}{{\hat{R}}_{11}} ) & cos ( \hat{α} ) \geq 0 \\ {tan}^{- 1} ( \frac{{\hat{R}}_{21}}{{\hat{R}}_{11}} ) + π & cos ( \hat{α} ) < 0\end{matrix} ,$$

or equivalently,

$$\hat{α} = \{ \begin{matrix}{tan}^{- 1} ( \frac{{\hat{R}}_{21}}{{\hat{R}}_{11}} ) & \frac{{\hat{R}}_{11}}{cos ( {sin}^{- 1} ( - {\hat{R}}_{31} ) )} \geq 0 \\ {tan}^{- 1} ( \frac{{\hat{R}}_{21}}{{\hat{R}}_{11}} ) + π & \frac{{\hat{R}}_{33}}{cos ( {sin}^{- 1} ( - {\hat{R}}_{31} ) )} < 0\end{matrix} .$$

As above, the inverse tangent was used to compute the estimate \hat{α}, although the inverse sine or inverse cosine can also be used.

Due to measurement errors, the measurement matrix [symbol] will have errors, and as a result the computed matrix

$$\hat{R} = {U}^{…} {U}^{- 1}$$

may not be unitary as is required. This may lead to inconsistencies in the solution. For example, the values of R₁₂, R₁₃, R₂₂, and R₂₃ calculated from the estimates \hat{α}, \hat{β}, and \hat{γ} formed using \hat{R}₁₁, \hat{R}₂₁, \hat{R}₃₁, \hat{R}₃₂ and \hat{R}₃₃ may not match the corresponding terms of \hat{R}= [symbol] U⁻¹. In general, it will be the case that

$$cos \hat{α} sin \hat{β} sin \hat{γ} - sin \hat{α} cos \hat{γ} \neq {\hat{R}}_{12}$$

$$cos \hat{α} sin \hat{β} cos \hat{γ} + sin \hat{α} sin \hat{γ} \neq {\hat{R}}_{13}$$

$$sin \hat{α} sin \hat{β} sin \hat{γ} + cos \hat{α} cos \hat{γ} \neq {\hat{R}}_{22}$$

$$sin \hat{α} sin \hat{β} cos \hat{γ} - cos \hat{α} sin \hat{γ} \neq {\hat{R}}_{23}$$

where \hat{α}, \hat{β}, and \hat{γ} are the estimates of α, β, and γ.

An alternative method for estimating α, β, and γ is to define \hat{α}, \hat{β}, and \hat{γ} as the parameters which minimize the Frobenius norm of the matrix

$${‖ R - \hat{R} ‖}_{F} = {‖ R - {U}^{...} {U}^{- 1} ‖}_{F} = {‖ [ \begin{matrix}cos αcos β & cos αsin βsin γ - sin αcos γ & cos αsin βcos γ + sin αsin γ \\ sin αcosβ & sin αsin βsin γ + cos αcos γ & sin αsin αcos γ - cos αsin γ \\ - sin β & cos βsin γ & cos βcos γ\end{matrix} ] - {U}^{...} {U}^{- 1} ‖}_{F} = {‖ [ \begin{matrix}cos αcos β & cos αsin βsin γ - sin αcos γ & cos αsin βcos γ + sin αsin γ \\ sin αcos β & sin αsin βsin γ + cos αcos γ & sin αsin βcos γ - cos αsin γ \\ - sin β & cos βsin γ & cos βcos γ\end{matrix} ] - [ \begin{matrix}{\hat{R}}_{11} & {\hat{R}}_{12} & {\hat{R}}_{13} \\ {\hat{R}}_{21} & {\hat{R}}_{22} & {\hat{R}}_{23} \\ {\hat{R}}_{31} & {\hat{R}}_{32} & {\hat{R}}_{33}\end{matrix} ] ‖}_{F}$$

where

$${‖ A ‖}_{F} = \sqrt{{\sum }_{i} {\sum }_{j} {\vert {A}_{i , j} \vert}^{2}} .$$

The Frobenius norm ∥R− [symbol] U⁻¹∥_{F} can be used as a measure of the reliability of the estimates \hat{α}, \hat{β}, and \hat{γ}, or equivalently, as a measure of the estimation error.

In an embodiment in which angle of arrival measurements can be taken from N reference devices, where N is greater than 3, and if the angle of arrival for these devices in the global coordinate system is known, a least-squared estimate of R can be developed. For the case of N devices, we define

$$U = [ {u}_{1} … {u}_{N} ] ,$$

$$and$$

$${U}^{...} = [ {{u}^{...}}_{1} … {{u}^{...}}_{N} ] .$$

and note that, as before

$${U}^{...} = RU$$

The least-squared estimate of R is then given by

$${\hat{R}}_{L S} = {U}^{...} {{U}^{H} ( U {U}^{H} )}^{- 1}$$

where here the least squared error is defined in terms of the Frobenius norm. In the case that N=3, then

$${{U}^{H} ( U {U}^{H} )}^{- 1} = {U}^{- 1}$$

and \hat{R}_{LS}= [symbol] U⁻¹ as above.

In an embodiment in which there are fewer than three measurements available, the matrix R can be estimated as

$${\hat{R}}_{MinNorm} = {{U}^{...} ( {U}^{H} U )}^{- 1} {U}^{H}$$

where \hat{R}_{MinNorm} is the minimum Frobenius norm solution satisfying [symbol] =R U.

In another embodiment, one or more of the Euler rotation angles α, β, γ are known. A rotation angle may be known when some aspect of the associated reference device's orientation is known, e.g. when the reference device is inclined at a known angle with respect to the horizontal plane or the force of gravity. For example, in the case that β=0, the matrix R becomes

$$R = {[ \begin{matrix}cos αcos β & cos αsin βsin γ - sin αcos γ & cos αsin βcos γ + sin αsin γ \\ sin αcos β & sin αsin βsin γ + cos αcos γ & sin αsin βcos γ - cos αsin γ \\ - sin β & cos βsin γ & cos βcos γ\end{matrix} ]}_{β = 0} = [ \begin{matrix}cos α & - sin αcos γ & sin αsin γ \\ sin α & cos αcos γ & cos αsin γ \\ 0 & sin γ & cos γ\end{matrix} ] .$$

With knowledge that β=0, γ and α can be estimated as

$$cos \hat{γ} = {\hat{R}}_{33}$$

$$\hat{γ} = \{ \begin{matrix}{tan}^{- 1} ( \frac{{\hat{R}}_{32}}{{\hat{R}}_{33}} ) & cos ( \hat{γ} ) \geq 0 \\ {tan}^{- 1} ( \frac{{\hat{R}}_{32}}{{\hat{R}}_{33}} ) + π & cos ( \hat{γ} ) < 0\end{matrix} .$$

$$and$$

$$cos \hat{α} = {\hat{R}}_{11}$$

$$\hat{α} = \{ \begin{matrix}{tan}^{- 1} ( \frac{{\hat{R}}_{21}}{{\hat{R}}_{11}} ) & cos ( \hat{α} ) \geq 0 \\ {tan}^{- 1} ( \frac{{\hat{R}}_{21}}{{\hat{R}}_{11}} ) + π & cos ( \hat{α} ) < 0\end{matrix} .$$

This approach can be modified in a straightforward manner in the case that β is known but is not equal to zero so that β=β₀.

Alternatively, as above, \hat{α} and \hat{γ} can be chosen as the parameters which minimize the Frobenius norm of the matrix

$${‖ R - \hat{R} ‖}_{F} = {‖ R - {U}^{...} {U}^{- 1} ‖}_{F} .$$

In an embodiment in which one or more of the values of α, β, γ are equal to zero, or alternatively, are equal to known values other than zero, modifications similar to those above can be made when calculating α, β, and γ which may improve the accuracy of the calculation.

In still another embodiment, R is calculated using a reduced number of measurements when one of the angles α, β, γ is known. As in the example above, we consider the case that β is known, but is not equal to zero so that β=β₀ with the result that

$$R = [ \begin{matrix}cos αcos {β}_{0} & cos αsin {β}_{0} sin γ - sin αcos γ & cos αsin {β}_{0} cos γ + sin βsin γ \\ sin αcos {β}_{0} & sin αsin {β}_{0} sin γ + cos αcos γ & sin αsin {β}_{0} cos γ - cos αsin γ \\ - sin {β}_{0} & cos {β}_{0} sin γ & cos {β}_{0} cos γ\end{matrix} ]$$

Since there are only two unknown parameters, the values α and β can be solved for using only two measurements using any of the following equations. Let R₁, R₂, and R₃ be defined as the sub-matrices

$${R}_{1} = [ \begin{matrix}cos αcos {β}_{0} & cos αsin {β}_{0} sin γ - sin αcos γ \\ sin αcos {β}_{0} & sin αsin {β}_{0} sin γ + cos αcos γ\end{matrix} ] ,$$

$${R}_{2} = [ \begin{matrix}cos αcos {β}_{0} & cos αsin {β}_{0} cos γ + sin αsin γ \\ - sin {β}_{0} & cos {β}_{0} cos γ\end{matrix} ] ,$$

$$and$$

$${R}_{3} = [ \begin{matrix}sin αsin {β}_{0} sin γ + cos αcos γ & sin αsin {β}_{0} cos γ - cos αsin γ \\ cos {β}_{0} sin γ & cos {β}_{0} cos γ\end{matrix} ] .$$

For an embodiment in which one of angles α, β, γ is known, only two measurements are needed to solve for the remaining two angles. As before, let the known directional vectors in the GCS be given by u₁ and u₂ where uᵢ=(xᵢ, yᵢ, zᵢ)^{T} and the directional vectors measured by the UE in the LCS be given by [symbol] and [symbol] where [symbol] . Define the matrices U₁, U₂, U₃ and [symbol] as

$${U}_{1} = [ \begin{matrix}{x}_{1} & {x}_{2} \\ {y}_{1} & {y}_{2}\end{matrix} ] {U}_{2} = [ \begin{matrix}{x}_{1} & {x}_{2} \\ {z}_{1} & {z}_{2}\end{matrix} ] {U}_{3} = [ \begin{matrix}{y}_{1} & {y}_{2} \\ {z}_{1} & {z}_{2}\end{matrix} ]$$

$$and$$

$${{U}^{...}}_{1} = [ \begin{matrix}{{x}^{...}}_{1} & {{x}^{...}}_{2} \\ {{y}^{...}}_{1} & {{y}^{...}}_{2}\end{matrix} ] {{U}^{...}}_{1} = [ \begin{matrix}{{x}^{...}}_{1} & {{x}^{...}}_{2} \\ {{z}^{...}}_{1} & {{z}^{...}}_{2}\end{matrix} ] {{U}^{...}}_{1} = [ \begin{matrix}{{y}^{...}}_{1} & {{y}^{...}}_{2} \\ {{z}^{...}}_{1} & {{z}^{...}}_{2}\end{matrix} ] .$$

With these definitions, we have

$${{U}^{...}}_{1} = {R}_{1} {U}_{1} {{U}^{...}}_{2} = {R}_{2} {U}_{2} {{U}^{...}}_{3} = {R}_{3} {U}_{3} ,$$

and thus

$${\hat{R}}_{1} = {{U}^{...}}_{1} {U}_{1}^{- 1} {\hat{R}}_{2} = {{U}^{...}}_{2} {U}_{2}^{- 1} {\hat{R}}_{3} = {{U}^{...}}_{3} {U}_{3}^{- 1} .$$

The two unknown angles from within the set α, β, γ can be estimated from any of \hat{R}¹, \hat{R}², or \hat{R}₃, though each of these submatrices may yield different estimates.

In another embodiment, R is calculated using a reduced number of measurements when two of the angles α, β, γ are known. The approach for this embodiment can be extended in a straightforward manner to the case where only one of the rotation angles is unknown as discussed above.

At 625, the method may include transmitting or requesting the rotations calculated at 620. The operations of 625 may be performed in accordance with examples as described herein. In some implementations, aspects of the operations of 625 may be performed by a device as described with reference to FIG. 1.

In an embodiment, the target device transmits the calculated rotations to a positioning entity. The positioning entity may use the rotations to translate orientation data from the target device LCS to orientation data in the GCS.

In an embodiment of method 600, a target device may determine the relationship between its LCS and the GCS using knowledge of its own location as well as the knowledge of the locations of a subset of reference devices from which the target device receives signals, where the locations are all in a common coordinate system. The target device uses the known locations to compute the AoAs in the global coordinate system, and measures the angles of arrival in its own LCS.

The target device uses these two sets of angles to solve for the rotations α, β, and γ that define the relationship between the LCS and the GCS. The target device can signal the AoA measurements taken of reference devices to one or more reference devices, to a positioning entity, or to the network. The AoA values can be signalled in the LCS along with the rotations α, β, and γ, or the angles can be signalled in the GCS.

A further aspect of this embodiment includes classification of the AoAs in terms of LOS, NLOS or combination thereof. The AoAs can be indicated as LOS or NLOS via a binary indicator [0 for LOS and 1 for NLOS]. In another embodiment, a soft value indicator [0, 0.1, 0.2, . . . , 0.9, 1] may indicate the probability that a performed AoA measurement, including first arrival path and additional paths are LOS or NLOS.

The signalling exchange in method 600 may be achieved via existing LPP signalling between a LMF and the target-device, e.g., Provide LocationInformation message, RRC signalling between the gNB and target-device, a SL positioning protocol (SLPP)/Ranging SL positioning protocol (RSPP), e.g., SL ProvideLocationInformation message between two or more devices, existing PC5 RRC signalling between two or more devices, or combinations thereof. In some implementations, a sidelink Positioning Server UE may be employed to receive reports on the AoA measurements or configure resources to measure the relevant AoAs. A SL Positioning Server UE may be an anchor or target UE or could be a separate UE participating the SL positioning session.

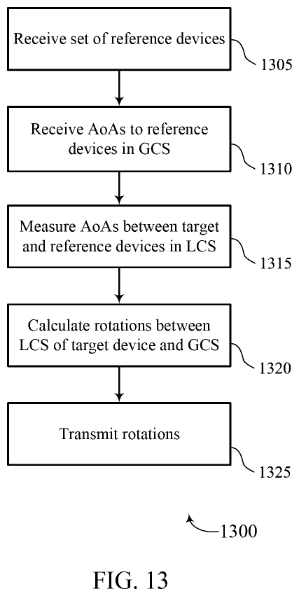

FIG. 13 illustrates a flowchart of a method 1300 that supports determining the orientation of a local coordinate system relative to a global coordinate system in accordance with aspects of the present disclosure. The operations of the method 1300 may be implemented by a device or its components as described herein. For example, operations of the method 1300 may be performed by a target device, which may be a UE 104 as described with reference to FIGS. 1 and 8. In some implementations, the device may execute a set of instructions to control the function elements of the device to perform the described functions. Additionally, or alternatively, the device may perform aspects of the described functions using special-purpose hardware.

Aspects of method 1300 are similar to aspects of method 600 described above. Accordingly, the following description is limited to reduce redundancy.

In method 1300, a positioning entity or other network device locates the target device and candidate reference devices within proximity of the target device, all within a common coordinate system which is typically a Euclidean coordinate system, though a polar coordinate system is also possible. The positioning entity or network may select a set of reference devices using method 1000, and the set of reference devices received by the target device at 1305 from the positioning entity or network. In another embodiment, the positioning entity or the network may request the location information from the target device with an associated accuracy.

The target device 104a receives AoAs to the reference devices in the GCS at 1310. The positioning entity may compute angles of arrival between the target device and reference devices, and cause the computed angles of arrivals in the GCS, relative to the target device, to be signalled to the target device. The angles of arrival may be sent by a single device, or each device may send its angle of arrival relative to the target device. In an embodiment, the target device transmits a request for a plurality of AoA values for reference devices within a predetermined distance range from the target device to the positioning entity, and the AoA values at 1310 are received in response to that request. The predetermined distance range may be a range of between a minimum distance, e.g. 10 meters, and a maximum distance, e.g. 100 meters.

The target device 104a then measures these same angles of arrival in the local coordinate system at 1315. The target device uses these two sets of angles to solve for the rotations α, β, and γ that define the relationship between its LCS and the GCS at 1320 as described with respect to 620, and signals the relationship between its LCS and the GCS to the positioning entity at 1325.

In another embodiment, once the target device knows the relationship between its LCS and the GCS, the target device may report all angles relative to the GCS. The above signalling exchange may be achieved via existing LPP signalling between a the LMF and the target-device, e.g., ProvideLocationInformation message, RRC signalling between the gNB and target-device, a new SL positioning protocol (SLPP)/Ranging SL positioning protocol (RSPP), e.g., SL ProvideLocationInformation message between two or more devices, existing PC5 RRC signalling between two devices or a combination thereof.

In some implementations, a SL Positioning Server UE may be employed to receive reports on the AoA measurements or configure resources to measure the relevant AoAs. A SL Positioning Server UE may be an anchor or target UE, or a separate UE participating the SL positioning session.

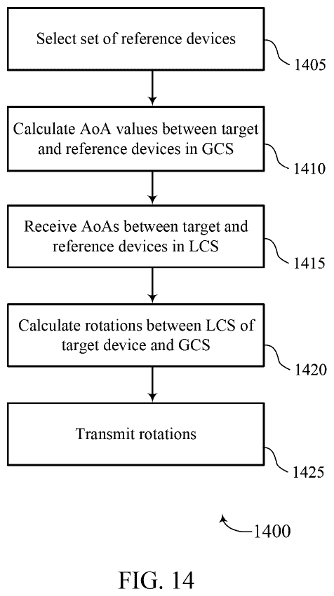

FIG. 14 illustrates a flowchart of a method 1400 that supports determining the orientation of a local coordinate system relative to a global coordinate system in accordance with aspects of the present disclosure. The operations of the method 1400 may be implemented by a device or its components as described herein. For example, operations of the method 1400 may be performed by a device such as a positioning entity as described with reference to FIGS. 1 and 9. In some implementations, the device may execute a set of instructions to control the function elements of the device to perform the described functions. Additionally, or alternatively, the device may perform aspects of the described functions using special-purpose hardware.

Aspects of method 1400 are similar to aspects of methods 600 and 1300 described above. Accordingly, the following description is limited to minimize redundancy.

In method 1400, the positioning entity or the network has knowledge of the locations of the target device and other devices in proximity of the target device, and the positioning entity uses this information to select a set of reference devices at 1405 as described with respect to method 1000. In addition, the positioning entity uses the location data to calculate AoA values between the target device 104a and one or more set of reference devices at 1410.

The target device 104a measures AoAs for signals received from the reference devices and reports LCS AoA measurements of signals received from devices in its proximity to the positioning entity or the network. The positioning entity receives the LCS AoA values from the target device at 1415.

Using these LCS measurements, the positioning entity or the network determine the relationship between the LCS and the GCS for the target device at 1420. The target device can subsequently report AoAs in its LCS, and the positioning entity or network can convert the LCS values to the GCS using the rotations calculated at 1420, even if the target device does not know the rotations α, β, and γ that are being used.

In another embodiment, the target device 104a can request the rotations a, B, and y from the positioning entity or the network so that the target device can determine its orientation in the GCS. In such an embodiment, the positioning entity or network transmits the calculated rotations to the target device at 1425.

Signalling exchanges between the target device and positioning entity 1400 may be achieved via existing LPP signalling between a the LMF and the target-device, e.g., ProvideLocationInformation message, RRC signalling between the gNB and target-device, a new SL positioning protocol (SLPP)/Ranging SL positioning protocol (RSPP), e.g., SL ProvideLocationInformation message between two or more devices, existing PC5 RRC signalling between two devices or combination thereof. In some implementations, a SL Positioning Server UE may be employed to receive reports on the AoA measurements or configure resources to measure the relevant AoAs. A SL Positioning Server UE may be an anchor or target UE or could be a separate UE participating the SL positioning session.

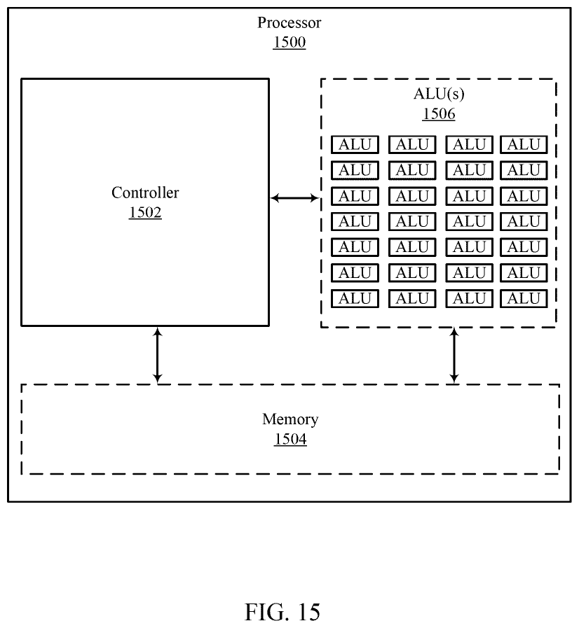

FIG. 15 illustrates an example of a processor 1500 that supports determining the orientation of a local coordinate system relative to a global coordinate system in accordance with aspects of the present disclosure. The processor 1500 may be an example of a processor configured to perform various operations in accordance with examples as described herein. The processor 1500 may include a controller 1502 configured to perform various operations in accordance with examples as described herein. The processor 1500 may optionally include at least one memory 1504, such as L1/L2/L3 cache. Additionally, or alternatively, the processor 1500 may optionally include one or more arithmetic-logic units (ALUs) 1500. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating timing of operations.

The controller 1502 may be configured to fetch (e.g., obtain, retrieve, receive) instructions from the memory 1504 and determine subsequent instruction(s) to be executed to cause the processor 1500 to support various operations in accordance with examples as described herein. The controller 1502 may be configured to track memory address of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage flow of data within the processor 1500. The controller 1502 may be configured to control transfer of data between registers, arithmetic logic units (ALUs), and other functional units of the processor 1500.

The memory 1504 may include one or more caches (e.g., memory local to or included in the processor 1500 or other memory, such RAM, ROM, DRAM, SDRAM, SRAM, MRAM, flash memory, etc. In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, and the processor 1500, the controller 1502, and the memory 1504 may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1500 may be configured to support various operations in accordance with examples as described herein. In some implementation, the one or more ALUs 1500 may reside within or on a processor chipset (e.g., the processor 1500). In some other implementations, the one or more ALUs 1500 may reside external to the processor chipset (e.g., the processor 1500). One or more ALUs 1500 may perform one or more computations such as addition, subtraction, multiplication, and division on data. For example, one or more ALUs 1500 may receive input operands and an operation code, which determines an operation to be executed. One or more ALUs 1500 be configured with a variety of logical and arithmetic circuits, including adders, subtractors, shifters, and logic gates, to process and manipulate the data according to the operation. Additionally, or alternatively, the one or more ALUs 1500 may support logical operations such as AND, OR, exclusive-OR (XOR), not-OR (NOR), and not-AND (NAND), enabling the one or more ALUs 1500 to handle conditional operations, comparisons, and bitwise operations.

The processor 1500 may support wireless communication in accordance with examples as disclosed herein. The processor 1500 may be configured to or operable to support a means for orienting a target device in a global coordinate system using local coordinate measurements.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a plurality of angle-of-arrival (AoA) values, each of the AOA values representing an angle between a target device and a respective reference device within a global coordinate system;
measure a plurality of AoA values between the target device and each the respective reference devices within a local coordinate system of the target device;
calculate a first rotation value between a first axis of the global coordinate system and a first axis of the local coordinate system;
calculate a second rotation value between a second axis of the global coordinate system and a second axis of the local coordinate system; and
calculate a third rotation value between a third axis of the global coordinate system and a third axis of the local coordinate system.

2. The UE of claim 1, wherein the at least one processor is further configured to cause the UE to:
transmit, to a positioning entity, a request for the plurality of AoA values within the global coordinate system.

3. The UE of claim 1, wherein the at least one processor is further configured to cause the UE to:
transmit, to a positioning entity, a request for the plurality of AoA values for reference devices within a distance range from the target device.

4. The UE of claim 1, wherein the at least one processor is further configured to cause the UE to:
transmit, to a positioning entity, the calculated first rotation value, the calculated second rotation value, and the calculated third rotation value.

5. The UE of claim 1, wherein the at least one processor is further configured to cause the UE to:
convert the measured AoA values to corresponding AoA values within the global coordinate system; and
transmit the converted AoA values to a positioning entity.

6. The UE of claim 1, wherein the at least one processor is further configured to cause the UE to calculate one or more of the first rotation value, the second rotation value, and the third rotation value using at least three AoA values for at least three respective reference devices.

7. A processor for wireless communication, comprising:
at least one memory; and
a controller coupled with the at least one memory and configured to cause the controller to:
receive a plurality of angle-of-arrival (AoA) values, each of the AoA values representing an angle between a target device and a respective reference device within a global coordinate system;
measure a plurality of AoA values between the target device and each of the respective reference devices within a local coordinate system of the target device;
calculate a first rotation value between a first axis of the global coordinate system and a first axis of the local coordinate system;
calculate a second rotation value between a second axis of the global coordinate system and a second axis of the local coordinate system; and
calculate a third rotation value between a third axis of the global coordinate system and a third axis of the local coordinate system.

8. The processor of claim 7, wherein the processor is further configured to:
transmit, to a positioning entity, a request for the plurality of AoA values within the global coordinate system.

9. (canceled)

10. The processor of claim 7, wherein the processor is further configured to:
transmit, to a positioning entity, the calculated first rotation value, the calculated second rotation value, and the calculated third rotation value.

11. (canceled)

12. The processor of claim 7, wherein the processor is further configured to cause the UE to calculate one or more of the first rotation value, the second rotation value, and the third rotation value using at least three AoA values for at least three respective reference devices.

13. A method performed by a user equipment, the method comprising:
receiving a plurality of angle-of-arrival (AoA) values, each of the AoA values representing an angle between a target device and a respective reference device within a global coordinate system;
measuring a plurality of AoA values between the target device and each of the respective reference devices within a local coordinate system of the target device;
calculating a first rotation value between a first axis of the global coordinate system and a first axis of the local coordinate system;
calculating a second rotation value between a second axis of the global coordinate system and a second axis of the local coordinate system; and
calculating a third rotation value between a third axis of the global coordinate system and a third axis of the local coordinate system.

14. The method of claim 13, further comprising:
transmitting, to a positioning entity, a request for the plurality of AoA values within the global coordinate system.

15. The method of claim 13, further comprising:
transmitting, to a positioning entity, a request for the plurality of AoA values for reference devices within a distance range from the target device.

16. The method of claim 13, further comprising:
transmitting, to a positioning entity, the calculated first rotation value, the calculated second rotation value, and the calculated third rotation value.

17. An apparatus for performing a network function, the apparatus comprising:
at least one memory; and
at least one processor coupled with the at least one memory and configured to cause the apparatus to:
calculate a plurality of angle-of-arrival (AoA) values, each of the AoA values representing an angle between a target device and a respective reference device within a global coordinate system;
receive a plurality of AoA values between the target device and each of the respective reference devices within a local coordinate system of the target device;
calculate a first rotation value between a first axis of the global coordinate system and a first axis of the local coordinate system;
calculate a second rotation value between a second axis of the global coordinate system and a second axis of the local coordinate system; and
calculate a third rotation value between a third axis of the global coordinate system and a third axis of the local coordinate system.

18. The apparatus of claim 17, wherein the at least one processor is further configured to:
receive a second plurality of AoA values within the local coordinate system from the target device; and
convert the second plurality of AoA values within the local coordinate system to a second plurality of AoA values within the global coordinate system using the first, second and third rotation values.

19. The apparatus of claim 17, wherein the at least one processor is further configured to:
determine a location of the target device using the first, second and third rotation values.

20. The apparatus of claim 17, wherein the at least one processor is further configured to:
compare a set of candidate devices to a first distance from the target device and a second distance from the target device,
wherein the reference devices are selected from candidate devices that are greater than the first distance and less than the second distance from the target device.

21. The method of claim 13, further comprising:
converting the measured AoA values to corresponding AoA values within the global coordinate system; and
transmitting the converted AoA to a positioning entity.

22. The method of claim 13, further comprising:
calculating one or more of the first rotation value, the second rotation value, and the third rotation value using at least three AoA values for at least three respective reference devices.
